(19) United States
(12) Patent Application Publication
(10) Pub. No.: US 2020/0183240 A1
(43) Pub. Date: Jun. 11, 2020

(54) DEVICE SUBSTRATE

(71) Applicant: Au Optronics Corporation, Hsinchu (TW)

(72) Inventors: Hsiu-Chun Hsieh, Hsinchu City (TW); Yi-Wei Chen, Hsinchu County (TW)

(73) Assignee: Au Optronics Corporation, Hsinchu (TW)

(21) Appl. No.: 16/666,424

(22) Filed: Oct. 29, 2019

(30) Foreign Application Priority Data
Dec. 11, 2018 (TW) 107144638

(51) Int. Cl. G02F 1/1362; G02F 1/1333; G06F 3/041

(52) U.S. Cl. CPC G02F 1/136286; G06F 3/0412; G02F 1/13338

(57) ABSTRACT

A device substrate including a substrate, first fan-out lines, second fan-out lines, third fan-out lines, touch electrode lines, and active devices is provided. The substrate includes an active area and a peripheral area connected with the active area. The first fan-out lines, the second fan-out lines, and the third fan-out lines are disposed on the peripheral area. Each of the second fan-out lines is overlapped with one corresponding first fan-out line. The second fan-out lines and the first fan-out lines belong to different conductive layers. Each of the third fan-out lines is disposed between two corresponding first fan-out lines. The third fan-out lines and the first fan-out lines belong to the same conductive layer. The touch electrode lines are electrically connected with the third fan-out lines. The active devices are disposed on the active area and electrically connected with the first fan-out lines and the second fan-out lines.

### CROSS-REFERENCE TO RELATED APPLICATION

This application claims the priority benefit of Taiwan application serial no. 107144638, filed on Dec. 11, 2018. The entirety of the above-mentioned patent application is hereby incorporated by reference herein and made a part of this specification.

### BACKGROUND

### Technical Field

The present invention relates to a device substrate, and more particularly to a device substrate including a touch electrode line.

### Description of Related Art

At present, most of liquid crystal display panels on the market have an upper substrate, a lower substrate, and a liquid crystal layer between the two substrates. Generally, the liquid crystal display panel further includes a sealant that bonds the upper substrate and the lower substrate together, wherein the sealant surrounds the liquid crystal layer to avoid the liquid crystal flowing out from the side of the liquid crystal display panel.

With the advancement of technology, the resolution of the liquid crystal display panel is getting higher and higher. In order to increase the resolution of the liquid crystal display panel, the density of the wires in the liquid crystal display panel is also inevitably increased. However, when forming the sealant in the liquid crystal display panel, these wires easily hinder the curing of the sealant, resulting in incomplete curing of the sealant.

### SUMMARY

The invention provides a device substrate, which can improve the problem of incomplete curing of the sealant.

A device substrate of the present invention includes a substrate, a plurality of first fan-out lines, a plurality of second fan-out lines, a plurality of third fan-out lines, a plurality of touch electrode lines, and a plurality of active devices. The substrate has an active area and a peripheral area connected with the active area. The first fan-out lines, the second fan-out lines, and the third fan-out lines are located on the peripheral area. Each of the second fan-out lines is overlapped with one corresponding first fan-out line. The second fan-out lines and the first fan-out lines belong to different conductive layers. Each of the third fan-out lines is located between two corresponding first fan-out lines. The third fan-out lines and the first fan-out lines belong to the same conductive layer. The touch electrode lines are electrically connected with the third fan-out lines. The active devices are located on the active area and electrically connected with the first fan-out lines and the second fan-out lines.

In order to make the aforementioned features and advantages of the disclosure more comprehensible, embodiments accompanied with figures are described in detail below.

### BRIEF DESCRIPTION OF THE DRAWINGS

FIG. 1 is a top plan view of a device substrate in accordance with an embodiment of the present invention.

FIG. 2A is a top plan view of a device substrate in accordance with an embodiment of the present invention.

FIG. 2B is a cross-sectional view taken along a section line AA′ of FIG. 2A.

FIG. 3 is a cross-sectional view of a device substrate in accordance with an embodiment of the present invention.

FIG. 4 is a cross-sectional view of a device substrate in accordance with an embodiment of the present invention.

FIG. 5 is a top plan view of a device substrate in accordance with an embodiment of the present invention.

### DESCRIPTION OF THE EMBODIMENTS

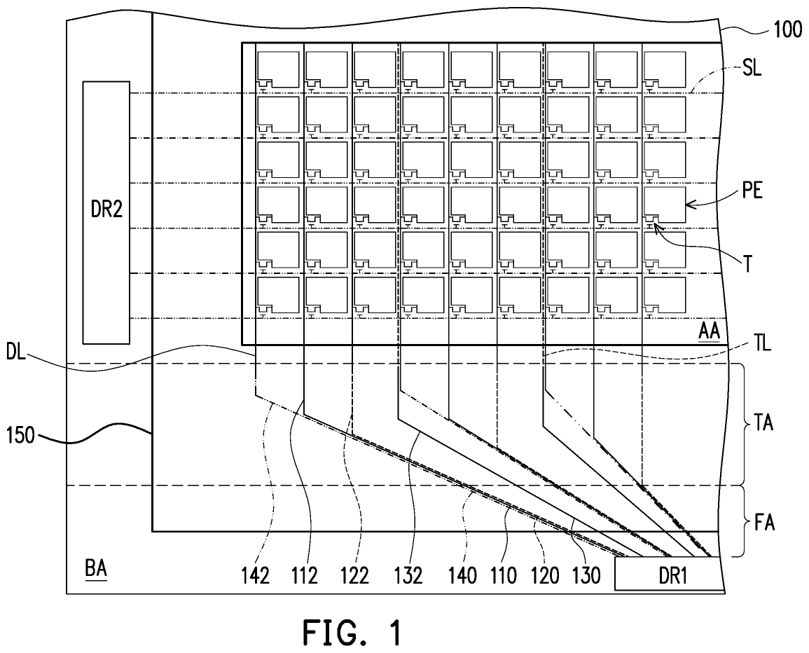

FIG. 1 is a top plan view of a device substrate in accordance with an embodiment of the present invention. In FIG. 1, the wires of different conductive layers (e.g., fan-out lines, transmission lines, scan lines, data lines, and touch electrode lines) are drawn using different line segments (e.g., solid lines, dashed lines, and dotted lines).

Referring to FIG. 1, a device substrate 10 includes a substrate 100, a plurality of first fan-out lines 110, a plurality of second fan-out lines 120, a plurality of third fan-out lines 130, a plurality of touch electrode lines TL, and a plurality of active devices T. In this embodiment, the device substrate 10 is a pixel array substrate, and the device substrate 10 further includes a source driving circuit DR1, a gate driving circuit DR2, a plurality of first transmission lines 112, a plurality of second transmission lines 122, a plurality of third transmission lines 132, a plurality of fourth fan-out lines 140, a plurality of fourth transmission lines 142, a plurality of scan lines SL, a plurality of data lines DL, a plurality of pixel electrodes PE, and a sealant 150.

The substrate 100 has an active area AA and a peripheral area BA connected with the active area AA. The source driving circuit DR1, the gate driving circuit DR2, the first fan-out lines 110, the second fan-out lines 120, the third fan-out lines 130, the fourth fan-out lines 140, the first transmission lines 112, the second transmission lines 122, the third transmission lines 132, the fourth transmission lines 142, and the sealant 150 are located on the peripheral area BA, wherein the sealant 150 surrounds the active area AA. In this embodiment, the sealant 150 is located on the first fan-out lines 110, the second fan-out lines 120, the third fan-out lines 130, the fourth fan-out lines 140, the first transmission lines 112, the second transmission lines 122, the third transmission lines 132 and the fourth transmission lines 142.

The active devices T and the pixel electrodes PE are located on the active area AA. The scan lines SL, the data lines DL, and the touch electrode lines TL extend from the peripheral area BA into the active area AA.

In the present embodiment, the portion of the peripheral area BA close to the source driving circuit DR1 includes a fan-out area FA and a transmission-layer area TA. The first fan-out lines 110, the second fan-out lines 120, the third fan-out lines 130, and the fourth fan-out lines 140 are located on the fan-out area FA. The first transmission lines 112, the second transmission lines 122, the third transmission lines 132, and the fourth transmission lines 142 are located on the transmission-layer area TA. In other embodiments, the portion of the peripheral area BA near the gate driving circuit DR2 also includes the fan-out area FA and the transmission-layer area TA, but the invention is not limited thereto.

The source driving circuit DR1 is electrically connected with the first fan-out lines 110, the second fan-out lines 120, the third fan-out lines 130, and the fourth fan-out lines 140. In this embodiment, the first fan-out line 110, the second fan-out line 120, and the fourth fan-out line 140 belong to different conductive layers, and each of the first fan-out lines 110 is overlapped with the corresponding one of the second fan-out lines 120 and the corresponding one of the fourth fan-out lines 140. In other words, each of the second fan-out lines 120 is overlapped with the corresponding one of the first fan-out lines 110 and the corresponding one of the fourth fan-out lines 140. One first fan-out line 110, one second fan-out line 120 and one fourth fan-out line 140 overlapped with each other are parallel to each other.

Each of the third fan-out lines 130 is located between two corresponding first fan-out lines 110. The third fan-out lines 130 and the first fan-out lines 110 belong to the same conductive layer. The third fan-out lines 130 do not overlap the first fan-out lines 110, the second fan-out lines 120, and the fourth fan-out lines 140. When the sealant 150 is cured by ultraviolet light, there is sufficient space between the fan-out lines in the direction perpendicular to the substrate 100 for ultraviolet light to pass therethrough, whereby the sealant 150 on the peripheral area BA can be cured more completely.

The first fan-out line 110, the second fan-out line 120, the third fan-out line 130 and the fourth fan-out line 140 are electrically connected with the first transmission line 112, the second transmission line 122, the third transmission line 132 and the fourth transmission line 142, respectively. In this embodiment, the first fan-out line 110, the second fan-out line 120 and the fourth fan-out line 140 are connected with the data line DL respectively through the first transmission line 112, the second transmission line 122 and the fourth transmission line 142. In this embodiment, the conductive layer of the first transmission line 112 is different from the conductive layer of the data line DL, so the first transmission line 112 may be electrically connected with the data line DL through the opening in the dielectric layer on the transmission-layer area TA or other conductive structures. In this embodiment, the conductive layer of the fourth transmission line 142 is different from the conductive layer of the data line DL, so the fourth transmission line 142 may be electrically connected with the data line DL through the opening in the dielectric layer on the transmission-layer area TA or other conductive structures. In this embodiment, the second transmission line 122 and the data line DL belong to the same conductive layer. In the present embodiment, the fan-out lines electrically connected with the data line DL includes the first fan-out line 110, the second fan-out line 120 and the fourth fan-out line 140, but the invention is not limited thereto. In other embodiments, the fan-out lines electrically connected with the data line DL includes two layers of the first fan-out line 110 and the second fan-out line 120, but does not include the fourth fan-out line 140.

The third fan-out line 130 is electrically connected with the touch electrode line TL through the third transmission line 132. In this embodiment, the conductive layer of the third transmission line 132 is different from the conductive layer of the touch electrode line TL, so the third transmission line 132 is electrically connected with the touch electrode line TL through the opening in the dielectric layer on the transmission-layer area TA or other conductive structures.

The data lines DL and the touch electrode lines TL extend from the peripheral area BA into the active area AA. The active devices T are electrically connected with the first fan-out lines 110, the second fan-out lines 120 and the fourth fan-out lines 140 through the data lines DL. In this embodiment, the active devices T are electrically connected with the first fan-out lines 110, the second fan-out lines 120 and fourth fan-out lines 140 through the data lines DL, the first transmission lines 112, the second transmission lines 122, and the fourth transmission lines 142. The active devices T are electrically connected with the gate drive circuit DR2. The touch electrode lines TL are overlapped with some of the data lines DL. The touch electrode lines TL are electrically connected with touch electrodes (not shown) located on the active area AA. Since the third fan-out lines 130 do not overlap the first fan-out lines 110, the second fan-out lines 120 and the fourth fan-out lines 140, the signal applied to the data lines DL and the signal applied to the touch electrode lines TL are not easy to interfere with each other. In other words, the capacitance loading of the data lines DL and the capacitance loading of the touch electrode lines TL can be reduced.

In some embodiments, a portion of the first fan-out lines 110, a portion of the second fan-out lines 120, and a portion of the fourth fan-out lines 140 are applied with negative-polarity voltage, another portion of the first fan-out lines 110, another portion of the second fan-out lines 120 and another portion of the fourth fan-out lines 140 are applied with positive-polarity voltage. One first fan-out line 110, one second fan-out line 120 and one fourth fan-out line 140 overlapped with each other are applied with voltage of the same polarity. In other words, the first fan-out line 110, the second fan-out line 120 and the fourth fan-out line 140 overlapped with each other all are applied with positive voltage or negative voltage. Thereby, the capacitances between the first fan-out line 110, the second fan-out line 120 and the fourth fan-out line 140 overlapped with each other can be reduced. In some embodiments, the data lines DL located on the transmission-layer area TA are rearranged through other transfer structures, so that a portion of the data lines DL to which positive voltage is applied and another portion of the data lines DL to which negative voltage is applied may be arranged alternately on the active area AA.

The scan lines SL extend from the peripheral area BA into the active area AA. The active devices T are electrically connected with the gate driving circuit DR2 through the scan lines SL. The pixel electrodes PE are electrically connected with the active devices T.

Based on the above, in the device substrate 10, the fan-out lines disposed on the fan-out area FA may have high density, and the problem of incomplete curing of the sealant 150 caused by the fan-out lines can be improved.

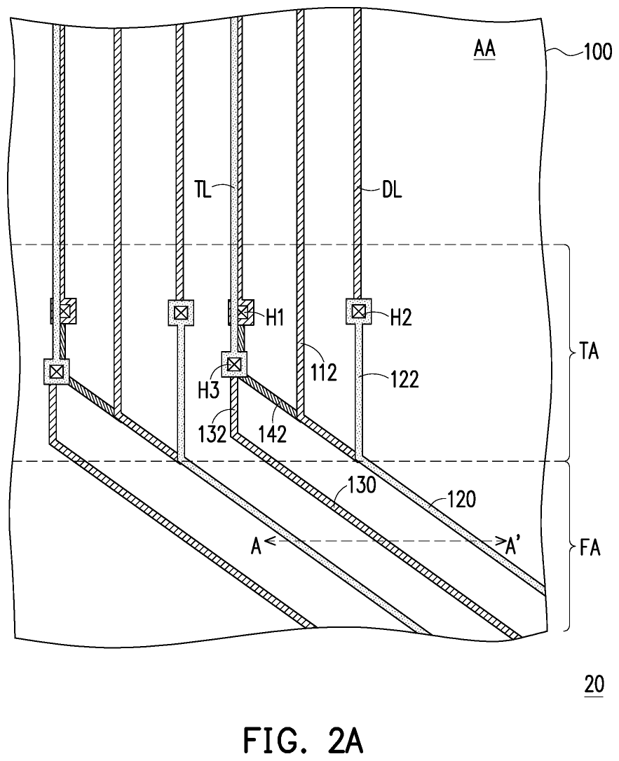

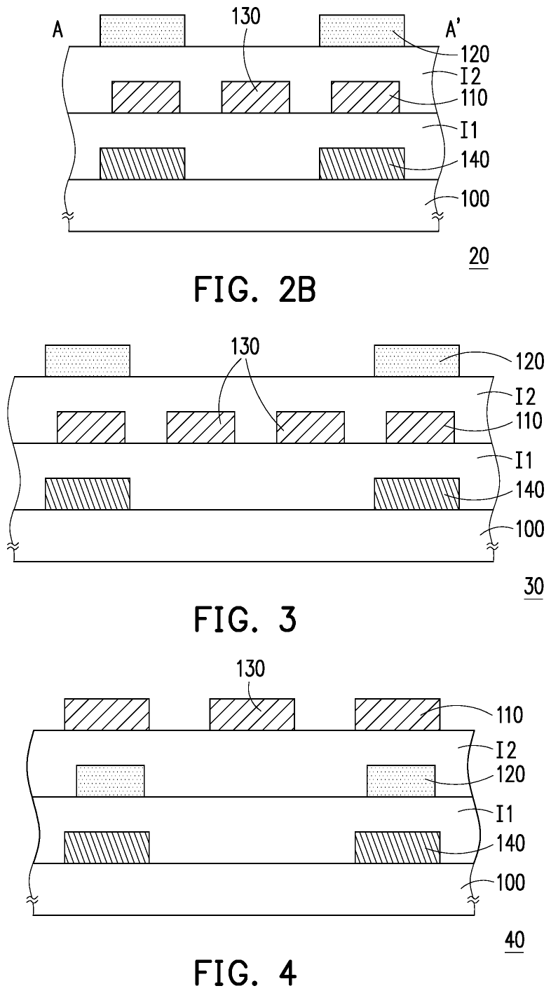

FIG. 2A is a top plan view of a device substrate in accordance with an embodiment of the present invention. FIG. 2B is a cross-sectional view taken along a section line AA′ of FIG. 2A. It is to be noted that reference numerals and a part of contents of the embodiment of FIG. 1 are adopted in the embodiment of FIG. 2A and FIG. 2B, wherein the same or similar elements are represented by the same or similar reference numerals, and descriptions of the same technical contents are omitted. The aforementioned embodiment may be referred for descriptions of the omitted parts, and detailed descriptions thereof are not repeated in the following embodiment. Each of the wires (e.g., fan-out lines, transmission lines, scan lines, data lines, and touch electrode lines) in different conductive layers is drawn as a single layer structure in FIG. 2B, but the present invention is not limited thereto. In other embodiments, each of the wires in the different conductive layers is a multilayer structure.

Referring to FIG. 2A and FIG. 2B, in a device substrate 20, the first fan-out lines 110 are located between the second fan-out lines 120 and the substrate 100. The fourth fan-out lines 140 are located between the first fan-out lines 110 and the substrate 100. Each of the third fan-out lines 130 is located between two corresponding first fan-out lines 110, and the third fan-out lines 130 and the first fan-out lines 110 belong to the same conductive layer. In some embodiments, the first fan-out line 110 and the third fan-out line 130 adjacent to each other are nearly parallel to each other. In other words, the included angle of the extension direction of the first fan-out line 110 and the extension direction of the third fan-out line 130 adjacent to the first fan-out line 110 is very small to even be ignored.

In this embodiment, a dielectric layer I1 is interposed between the fourth fan-out lines 140 and the first fan-out lines 110, and a dielectric layer 12 is interposed between the first fan-out lines 110 and the second fan-out lines 120.

The first fan-out line 110, the second fan-out line 120, the third fan-out line 130 and the fourth fan-out line 140 are electrically connected with the first transmission line 112, the second transmission line 122, the third transmission line 132 and the fourth transmission line 142, respectively.

In this embodiment, the data lines DL, the first fan-out lines 110, the first transmission lines 112, the third fan-out lines 130, and the third transmission lines 132 belong to the same conductive layer, and the touch electrode lines TL, the second fan-out lines 120 and the second transmission lines 122 belong to the same conductive layer. The fourth transmission line 142 is electrically connected with the data line DL through an opening H1 located in the dielectric layer I1. The second transmission line 122 is electrically connected with the data line DL through an opening H2 located in the dielectric layer 12. The third transmission line 132 is electrically connected with the touch electrode line TL through an opening H3 located in the dielectric layer 12.

Based on the above, in the device substrate 20, the fan-out lines on the fan-out area can be arranged as being overlapped with each other, therefore there is sufficient space between the fan-out lines in the direction perpendicular to the substrate for ultraviolet light to pass therethrough, whereby the problem of incomplete curing of the sealant due to ultraviolet light being blocked by the fan-out lines can be improved.

FIG. 3 is a cross-sectional view of a device substrate in accordance with an embodiment of the present invention. It is to be noted that reference numerals and a part of contents of the embodiment of FIG. 2B are adopted in the embodiment of FIG. 3, wherein the same or similar elements are represented by the same or similar reference numerals, and the descriptions of the same technical contents are omitted. The aforementioned embodiment may be referred for descriptions of the omitted parts, and detailed descriptions thereof are not repeated in the following embodiment.

Referring to FIG. 3, in a device substrate 30, two of the third fan-out lines 130 are located between two corresponding first fan-out lines 110.

Based on the above, in the device substrate 30, the fan-out lines on the fan-out area can be arranged as being overlapped with each other, therefore there is sufficient space between the fan-out lines in the direction perpendicular to the substrate for ultraviolet light to pass therethrough, whereby the problem of incomplete curing of the sealant due to ultraviolet light being blocked by the fan-out lines can be improved.

FIG. 4 is a cross-sectional view of a device substrate in accordance with an embodiment of the present invention. It is to be noted that reference numerals and a part of contents of the embodiment of FIG. 2B are adopted in the embodiment of FIG. 4, wherein the same or similar elements are represented by the same or similar reference numerals, and the descriptions of the same technical contents are omitted. The aforementioned embodiment may be referred for descriptions of the omitted parts, and detailed descriptions thereof are not repeated in the following embodiment.

Referring to FIG. 4, in a device substrate 40, the second fan-out lines 120 are located between the first fan-out lines 110 and the substrate 100.

In this embodiment, the first fan-out lines 110, the third fan-out lines 130, and the touch electrode lines belong to the same conductive layer, and the second fan-out lines 120 and the data lines belong to the same conductive layer. The touch electrode line can be electrically connected with the third fan-out line 130 without through an opening.

Based on the above, in the device substrate 40, the fan-out lines on the fan-out area can be arranged as being overlapped with each other, therefore there is sufficient space between the fan-out lines in the direction perpendicular to the substrate for ultraviolet light to pass therethrough, whereby the problem of incomplete curing of the sealant due to ultraviolet light being blocked by the fan-out lines can be improved.

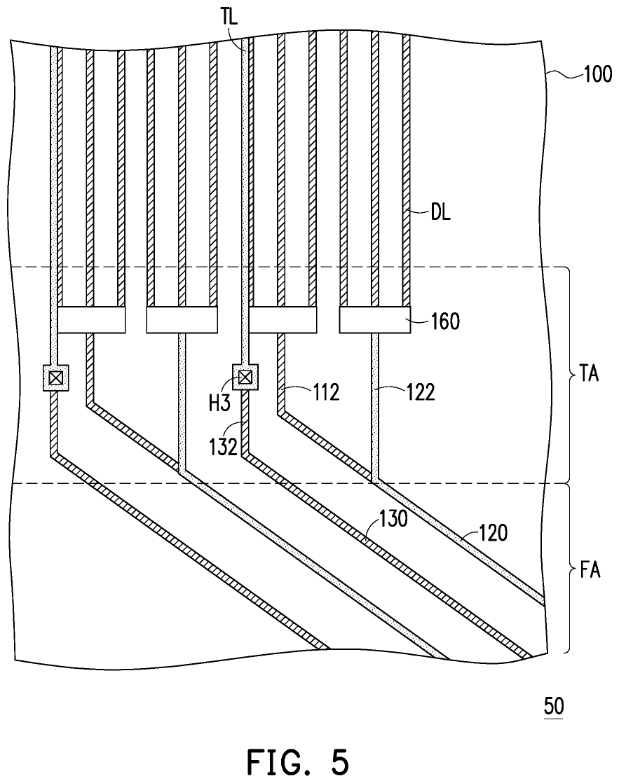

FIG. 5 is a top plan view of a device substrate in accordance with an embodiment of the present invention. It is to be noted that reference numerals and a part of contents of the embodiment of FIG. 2A are adopted in the embodiment of FIG. 5, wherein the same or similar elements are represented by the same or similar reference numerals, and the descriptions of the same technical contents are omitted. The aforementioned embodiment may be referred for descriptions of the omitted parts, and detailed descriptions thereof are not repeated in the following embodiment.

Referring to FIG. 5, a device substrate 50 further includes a plurality of multiplexers 160. The multiplexers 160 are electrically connected with the first fan-out lines (covered by the second fan-out lines 120 in FIG. 5) and the second fan-out lines 120 through the first transmission lines 112 and the second transmission lines 122.

With the setting of the multiplexers 160, the number of the fan-out lines for providing signal to the data lines DL can be reduced, i.e., the number of the fan-out lines is less than the number of the data lines DL, thereby improving the resolution of the display panel. In addition, since the number of the fan-out lines can be reduced, the problem of incomplete curing of the sealant due to ultraviolet light being blocked by the fan-out lines can be improved.

In summary, in the device substrate of the present invention, the fan-out lines overlapped with each other are disposed on the fan-out area, such that there is sufficient space between the fan-out lines in the direction perpendicular to the substrate for ultraviolet light to pass therethrough. Thereby, the problem of incomplete curing of the sealant due to ultraviolet light being blocked by the fan-out lines can be improved.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A device substrate, comprising:
a substrate having an active area and a peripheral area connected with the active area;
a plurality of first fan-out lines located on the peripheral area;
a plurality of second fan-out lines located on the peripheral area, wherein each of the second fan-out lines is overlapped with one corresponding the first fan-out lines, and the second fan-out lines and the first fan-out lines belong to different conductive layers;
a plurality of third fan-out lines located on the peripheral area, wherein each of the third fan-out lines is located between two corresponding first fan-out lines, and the third fan-out lines and the first fan-out lines belong to the same conductive layer;
a plurality of touch electrode lines electrically connected with the third fan-out lines; and
a plurality of active devices disposed on the active area and electrically connected with the first fan-out lines and the second fan-out lines.

2. The device substrate of claim 1, wherein the first fan-out lines are located between the second fan-out lines and the substrate.

3. The device substrate of claim 1, wherein the second fan-out lines are located between the first fan-out lines and the substrate.

4. The device substrate of claim 1, further comprising a plurality of fourth fan-out lines located on the peripheral region, wherein each of the first fan-out lines is overlapped with a corresponding one of the fourth fan-out lines.

5. The device substrate of claim 4, wherein the active devices are electrically connected with the first fan-out lines, the second fan-out lines, and the fourth fan-out lines.

6. The device substrate of claim 1, wherein each two of the third fan-out lines are located between two corresponding first fan-out lines.

7. The device substrate of claim 1, further comprising a plurality of multiplexers electrically connected with the first fan-out lines and the second fan-out lines.

8. The device substrate according to claim 1, wherein a portion of the first fan-out lines and a portion of the second fan-out lines are applied with negative polarity voltage, and another portion of the first fan-out lines and another portion of the second fan-out lines are applied with positive polarity voltage.

9. The device substrate of claim 8, wherein a voltage of the same polarity is applied to one of the first fan-out lines and one of the second fan-out lines overlapped with each other.

10. The device substrate of claim 1, wherein one of the first fan-out lines and one of the second fan-out lines overlapped with each other are parallel to each other.

11. The device substrate of claim 1, further comprising a sealant on the first fan-out lines and the second fan-out lines.

12. The device substrate of claim 1, wherein the third fan-out lines do not overlap the first fan-out lines and the second fan-out lines.

13. The device substrate of claim 1, further comprising a plurality of data lines, wherein the active devices are electrically connected with the first fan-out lines and the second fan-out lines through the data lines.
